(19) United States
(12) Patent Application Publication
(10) Pub. No.: US 2002/0113430 A1
(43) Pub. Date: Aug. 22, 2002

(54) Non-metallic security elements for authentification purposes

(76) Inventors: Luciano Beghello, Huddinge (SE); Martti Toivakka, Oberanven (LU)

Correspondence Address: BANNER & WITCOFF, 1001 G STREET N W, SUITE 1100, WASHINGTON, DC, 20001, US

(21) Appl. No.: 09/861,849

(22) Filed: May 22, 2001

(30) Foreign Application Priority Data
Feb. 19, 2001 (SE) 0100552-9

(51) Int. Cl. B42D 15/00

(52) U.S. Cl. 283/83

(57) ABSTRACT

A durable non-metallic security element, such as a security thread, foil stripe or patch, is manufactured from a conductive polymer. Magnetic polymers are added, either evenly over the entire length or area of the security element, or according to a predetermined pattern. The security element may further comprise printed information, visible in transmitted or incident light.

The present invention concerns security elements for use in security paper and similar applications and in particular such elements based on the use of conducting and/or magnetic polymer materials.

### BACKGROUND OF THE INVENTION

The availability of advanced photocopying machines, computer software for graphic design, and advanced printing equipment has made it easier to replicate valuable documents, such as bank notes, traveller's cheques, bank cheques, passports, identification documents, travel documents, tickets, lottery tickets and driving licenses, to mention a few examples. Consequently there is a demand for methods for protecting documents against forgery, including security features to be incorporated on or even into the substrate used for said valuable documents.

When considering security features, it should be noted that there is a demand for primary features, that is security features, which are easily identified without the aid of special equipment, as well as secondary security features, or features identified only through a closer study of the document. Primary security features include water marks, tactile details, micro text, holograms and similar features, readily discernible by an average user. Secondary features include fluorescence, e.g. UV-fluorescence, conductivity, reflectance, magnetic properties etc, possible to determine using suitable apparatus. The detection of secondary security features can be done by automatic measurements, which can be performed without human contribution, thereby possible to be incorporated in vending machines, exchange automates, automatic telling machines etc.

One group of security elements, which exhibits both primary and secondary security features, is the group comprising the so called security thread, bands, foil stripes and patches. These elements, and in particular security threads are frequently used as a means of preventing forgery of bank notes and other documents, where the issue of authenticity is important. Security threads are presently manufactured from thin metal foil or metal coated plastic foil, cut into threads with a width of about 0.3 to 30 mm, often about 0.5 to 15 mm, and incorporated in the paper during the paper making process. The security thread can be totally embedded in the paper, visible only in transmitted light, or partially embedded, being exposed and embedded at alternating portions. The presence of the security thread can be seen or felt by the consumer, using the bank notes or security documents. The presence of a security thread can also be mechanically or electronically verified, for example by bank note sorting machines, vending machines, automatic teller machines, exchange automates etc by measuring the conductivity of the thread.

In order to make the security element, e.g. the thread, band, foil stripe or patch more difficult to forge, it can be printed with micro text in positive or negative print, for example with numerals and symbols corresponding to the currency and value of the bank note, in which the element is used. This is frequently applied to security threads. Further, magnetic stripes can be added, either longitudinally along the length of the thread, or transversally, forming bar shaped, square or rectangular magnetic areas along the length of thread, separated by non-magnetic areas.

The metal based or metal coated security threads and foil stripes are prone to breaking or cracking, leading to discontinuities in their conductive properties. A thick and inflexible thread may also dissociate from the paper during heavy use, for example when a bank note is repeatedly folded or wrinkled. When breaking or cracking, the security thread or foil stripe no longer exhibits the same conductivity, leading to the bank note being refused by automates and vending machines. A partially dissociated security thread or foil stripe also raises suspicions in the eyes of the consumer, making him/her doubt the authenticity of the bank note.

Further, metallic security elements, such as threads or foils, have turned out to be susceptible of corrosion. This is particularly troublesome for security threads where a thin metal layer, e.g. aluminium, is in contact with a magnetic coating, for example a metallic ink or other coating containing iron.

Prior Art

Currently used security threads consist of a thin transparent carrier film and at least one electrically conductive metal layer, as exemplified by the disclosure of U.S. Pat. No. 5,599,047. The electrically conductive metal layer is either a vacuum metallized layer, a bronze ink or an imitation metal printing ink. A typical security thread according to U.S. Pat. No. 5,599,047 consists of a carrier film, having a thickness of about 10 to 30 micrometers, activatable ink 0.5 to 2 micrometers, at least one metal layer of about 1/100 micrometer on one side of the carrier, and magnetic ink having a thickness of about 1 to 5 micrometers. In order to protect the thin metallic layer, a layer of lacquer with a thickness of about 10 micrometers can be applied over the metallic layer. The thread disclosed is said to have the advantage, that cracks in the metallic conductive layer extending over the total thread width allegedly do not lead to a complete loss of electric conductivity. This is attributed to the adjacent conductive magnetic layer, which would bridge the crack.

Another security thread is disclosed in U.S. Pat. No. 5,803,503, where the security thread has added primary, as well as secondary features. The security element consists of a transparent film strip that bears negative writing readily capable of visual checking and is additionally provided with electrically conductive and magnetic substances in the form of a metallic layer and a magnetic layer. The metallic layer may include bronze inks, imitation metal ins or vacuum evaporated metal layers. The magnetic layer may consist of magnetic ink.

Yet another security thread is disclosed in U.S. Pat. No. 6,030,691, namely a thread consisting of an translucent plastic film with an at least partly opaque coating. The coating has translucent areas in the form of visually and/or machine readable characters or patterns that form first information. In addition to this, second information in the form of visually and/or machine readable characters or patterns (e.g. metallic coating) is disposed in the plastic film, said second information differing from the first information with respect to its size and/or visual impression.

The objective of the present invention is to make available improved security threads and foil stripes, exhibiting better durability, chemical and mechanical resistance to wear and ageing, and exhibiting improved electrical properties during the entire life span of the bank note or security document.

### SUMMARY OF THE INVENTION

The present inventors have surprisingly shown that conductive polymers can be used for the manufacture of security elements, such as threads, bands, foil stripes, and patches exhibiting improved characteristics, compared to prior art security elements of comparable type. The present invention makes available a novel non-metallic security element comprising a conductive polymer, and preferably a transparent or at least translucent conductive polymer. The features of the invention are as set out in the attached independent and dependent claims, incorporated here by reference.

### SHORT DESCRIPTION OF THE FIGURES

The invention will be disclosed in further detail in the description, non-limiting examples and claims, and illustrated in the attached drawings, in which

FIG. 1 shows a cross section of a security element according to the invention, with a conductive polymer layer 1, functional particles 2, ink 3, adhesive 4, the thickness of the composite being indicated as A (preferably less than about 20 micrometers),

FIG. 2 shows the inventive security element from above, illustrating possible added security features; such as clear text print 5, micro text 6, macro text 7, and 3 indicating ink, preferably fluorescent ink or laser colour; the width of the element being indicated as B (about 1 to about 4 mm),

FIG. 3 shows an embodiment with magnetic particles, which can be added overlapping some of the information described above, or alternating therewith,

FIG. 4 shows a cross section of a foil stripe with added security features, glued to the surface, wherein the conductive polymer is indicated 1, functional particles 2, adhesive 4 and the added features, e.g. holograms 8. The thickness of the composite element is indicated as C (preferably less than about 20 micrometers), and

FIG. 5 shows schematically a band having a width D (for example about 10 to 20 mm) and carrying additional features 8, over print 9 and conductive polymers of different orientation 10.

### DESCRIPTION

The term “security element” is used here to encompass physical elements, incorporated into, associated with or added to objects in order to aid in determining the authenticity of the object, and to prevent the falsification of said object. Examples of objects on or in which the inventive security features may be used are valuable documents, bank notes, cheques, contracts, identity cards, driving licenses, seals etc.

The term “security feature” means in this context a property of said security element, possible to ascertain either with the human senses, e.g. visually, or with the aid of a suitable apparatus, e.g. an apparatus for measuring the conductivity.

Paper is a material traditionally associated with high resistivity or low conductivity. As an example it can be mentioned that paper has been used as insulation in electric applications, for example in cables. The resistivity of paper is in the interval of about 10¹¹−10⁻Ohm cm and the corresponding conductivity in the interval of about 10⁻¹¹−19⁻¹⁴ S/cm.

Classical polymers have traditionally had low electrical conductivity. Attempts to increase the conductivity of polymers has comprised the addition of conductive fillers, such as carbon blacks, metal particles and flakes, metal fibres, carbon fibres and the like. A new class of organic polymers capable of conducting electricity has however recently been developed. These polymers become conductive upon partial oxidation or reduction, a process commonly referred to as doping.

Suitable polymers for use according to the present invention are conductive polymers exhibiting a conductivity in the range of about 10⁻¹⁰ to 10² S/cm, either alone or blended with commercially available so called commodity polymers. One example is the group of polyaniline polymers, e.g. Panipol® (Panipol Ltd., Porvoo, Finland), and these polymers can be used as such, or blended with polyester, polyethylene, polypropylene, polystyrene, PVC, phenol formaldehyde resins, and different types of thermoplastic elastomers.

Another example is the polymer known as PEDOT (Poly[ethylenedioxythiophene]) which can reach an electrical conductivity of about 10⁴ S/m. Depending on the desired properties, such as strength, PEDOT may have to be blended with other polymers, for example added to a matrix of polymers such as polyester, polyethylene, polypropylene, polystyrene, PVC, phenol formaldehyde resins, and different types of thermoplastic elastomers.

Another example is the conductive polymers based on 3,4-ethylenedioxythiophene, a compound also known as the EDT monomer (sold as Baytron M™ or EDT, Bayer Corporation Electronic Chemicals, Pittsburgh, USA). The conductive polymer poly-3,4-ethylenedioxythiophene-polystyrenesulfonate (Baytron P™ or PEDT/PSS, Bayer Corporation Electronic Chemicals, Pittsburgh, USA) is also available as an aqueous dispersion.

The strength and functional properties of the polymer material to be processed into a security element according to the present invention can be modified by the addition of pigments and/or fillers. The above mentioned polymers make it possible to manufacture electrically conductive, coloured and, if desired, transparent thin films.

According to an embodiment of the present invention, the conductive polymer material is transparent or at least translucent under normal lighting conditions. Normal lighting conditions means that information, e.g. writing, printed on the polymer, would be visible in transmitted light, e.g. when holding the security element against a light source.

By choosing the conductive polymer and possible additives, fillers etc the conductivity or resistance of the thread or foil can be accurately chosen.

According to an embodiment of the present invention, the conductive polymer material is applied in two or more layers, each layer having its specific conductivity, and running parallel either side by side or one above the other, viewed from the perspective of the thread or foil being in place on or in the paper. This would add a novel and surprising security feature in that different conductivity reading would be obtained, depending on the place of measurement.

The security thread can be applied to the surface of the paper, embedded into the paper or quasi woven into the paper, so that is exposed at the surface and embedded in the paper at regular intervals.

The conductive polymer layer can be cut into threads having a width of about 0.3 to about 3 mm, or any other width suitable for use in security documents, such as passports, driving licences, monetary documents, such as bank notes, cheques, etc.

The conductive polymer can also be cut into bands of foil, wider than the above width of security threads, for example about 10 to 30 mm wide. Such bands, also known as “foil stripes” can comprise additional security features, such as holograms, glued or otherwise affixed to the foil. The foil can also be manufactured with transverse and/or longitudinal areas of differing conductivity, in repeating patterns, giving each type of foil a unique conductivity profile.

The conductive polymer can also be cut into patches of desired size and geometry, for example round, oval, square or rectangular patches. These patches can also comprise additional security features, such as hologramns, glued or otherwise affixed to the patch.

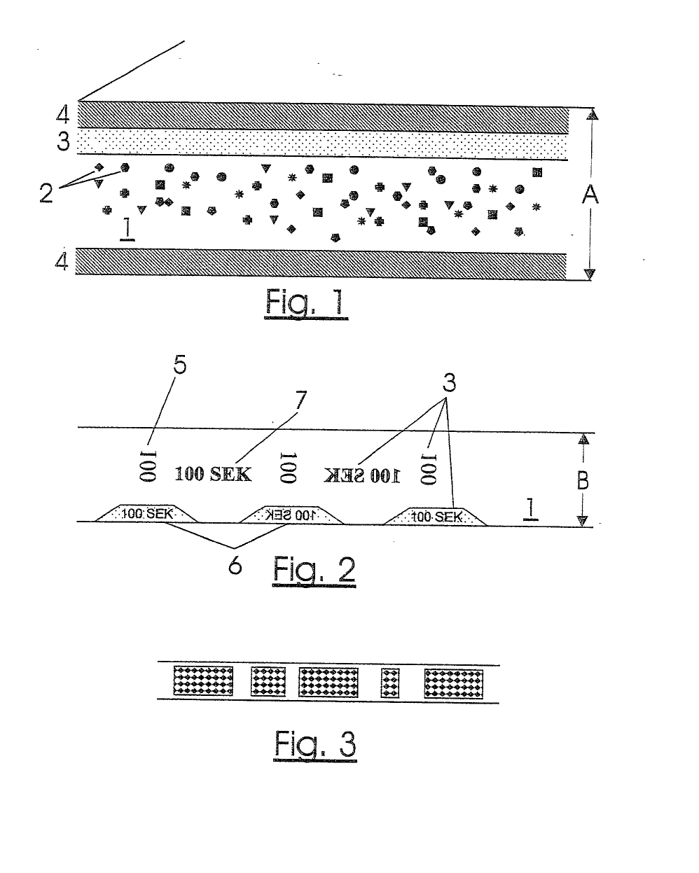

The inventive thread, foil/stripes, and patches can also be superimposed with printed information without negatively influencing the conductivity of the underlying polymer material, for example using fluorescent ink. An example is shown in FIG. 1, illustrating a conductive polymer material 1, containing functional additives 2, a layer of printed information 3 and adhesive layers 4. The functional additives can be used to create a patter or signal along the polymer based security element. In order to mask the location of said additives, for example magnetic particles, the conductive polymer can also be surrounded by two layers of opaque print (not shown). The printed information 3 is then applied to one or both of said opaque layers.

The invented security element can also consist of a transparent or translucent conductive material, coated with an opaque coating, leaving areas exposed, said areas forming visible and/or machine readable information, such as symbols, letters and numbers. When viewed in transmitted light, these symbols would appear lighter than the surrounding security element, which in turn would appear darker against e.g. the paper. When viewed in incident light, these symbols may appear darker, as they reflect less light than the surrounding opaque coating.

The invented security element can also consist of a transparent or translucent conductive material, printed with an opaque coating in delimited areas, said areas forming visible and/or machine readable information, such as symbols, letters and numbers. When viewed in transmitted light, these symbols would appear darker than the surrounding security element, as they are printed in opaque ink, the surrounding element being non-coated.

The inventive security element can be given additional security features as illustrated in FIG. 2. Information can be added by printing opaque symbols on the conductive material, or by gluing or otherwise affixing further elements on the conductive polymer material, such as holograms, cinegrams etc. FIG. 2 illustrates one such embodiment, wherein the polymer material carries clear text print 5, micro text 6, macro text 7, executed in ink 3, preferably fluorescent ink or laser colour; the width of the element being indicated as B (about 1 to about 4 mm).

As indicated above, magnetic codes can be added to the security element, either in the form of magnetic particles added to the polymer mixture, or attached to the polymer element. This is illustrated in FIG. 3. In order to mask the location of said magnetic particles, a layer of ink, either with or without printed information, can be added on one or both sides of the security element.

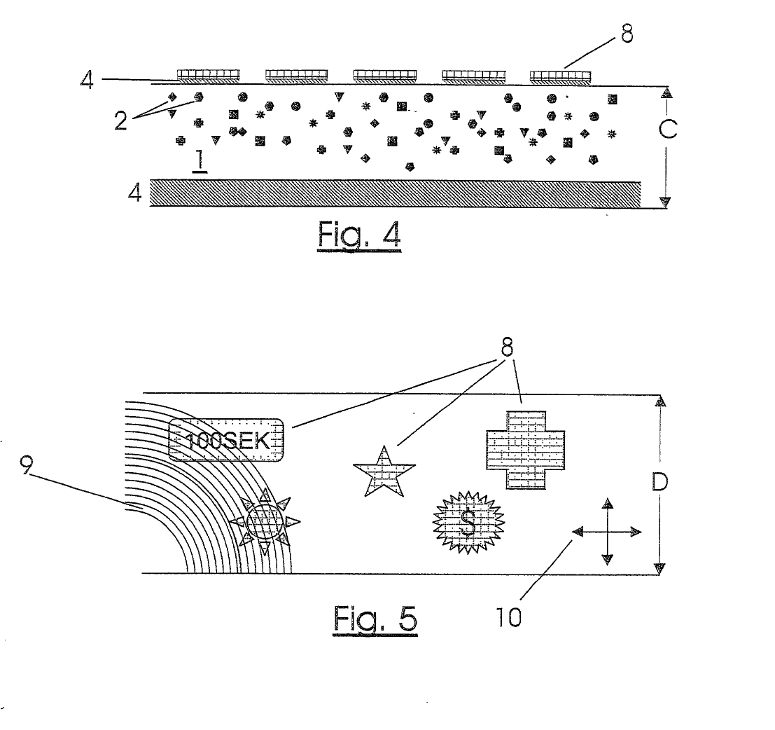

FIG. 4 shows how additional security elements can be attached to the conductive polymer based element 1, with the aid of adhesives 4. When it is necessary to mask the polymer layer, e.g. in order to hide information contained thereon, a layer of opaque ink (not shown) can be applied to one or both sides of the polymer 1.

FIG. 5 shows band according to the invention, having a width D (for example about 10 to 20 mm) and carrying additional features 8, e.g. holograms, cinegrams etc, over print 9, and conductive polymers of different orientation 10. The feature 10 is based on the directional anisotropy of conductivity, which enables the differentiation between the direction of the security element.

The invention makes it possible to simplify the manufacturing process, for example in that the step of vacuum deposition of metal and/or the printing using metal inks, can be abandoned. Further, the non-metallic security element according to the present invention is not only more durable and flexible than the metal based or metallised threads, but also lighter and less costly to manufacture.

The inventive security element can also be made thinner than conventional elements, as it consists of fewer layers, without loss of durability and function. The inventive security element has preferably a thickness of about 20 micrometers, compared to about 30 to 40 micrometers or more, usually encountered in prior art elements.

The security element according to the present invention can also be printed onto the surface of the substrate or paper, which autenticity is to be secured.

An advantage of conductive polymers, compared to metal layers, is the directional anisotropy of conductivity, which enables the differentiation between the direction of the security element, thereby adding yet another secondary security feature. An additional advantage is that the inventive security element is resistant to corrosion.

Although the invention has been described with regard to its preferred embodiments, which constitute the best mode presently known to the inventors, it should be understood that various changes and modifications as would be obvious to one having the ordinary skill in this art may be made without departing from the scope of the invention as set forth in the claims appended hereto.

1. Non-metallic security element, characterized in said element comprising at least one electrically conductive polymer.

2. Non-metallic security element according to claim 1, characterized in that said electrically conductive polymer is a doped organic polymer.

3. Non-metallic security element according to claim 1, characterized in said electrically conductive polymer is polyaniline.

4. Non-metallic security element according to claim 1, characterized in said electrically conductive polymer is a blend of polyaniline and at least one polymer chosen among polyester, polyethylene, polypropylene, polystyrene, PVC, a phenol formaldehyde resin, or a thermoplastic elastomer.

5. Non-metallic security element according to claim 1, characterized in that said electrically conductive polymer is at least transluscent under normal lighting conditions.

6. Non-metallic security element according to claim 1, characterized in further comprising magnetic particles.

7. Non-metallic security element according to claim 6, characterized in that said magnetic particles are evenly distributed over the entire length of the element.

8. Non-metallic security element according to claim 6, characterized in that said magnetic particles are distributed according to a predetermined pattern over the length of the element.

9. Non-metallic security element according to any one of claims 1-8, characterized in said element is cut in the shape of a thread, a foil or patches, for incorporation in a security document.

10. Non-metallic security element according to any one of claims 1-8, characterized in said element is applied to the surface by means of printing.

11. Non-metallic security element cut in the shape of a foil or a patch, characterized in that at least one further security feature in the form of a hologram is affixed to said foil or patch.

12. Non-metallic security element according to 5, characterized in said element comprising information in the form of symbols visible in transmitted light.

13. Non-metallic security element according to any one of claims 1-8, characterized in said element comprising information in the form of symbols visible in incident light.

14. Security document comprising a non-metallic security element according to any one claims 1-13.

15. Bank note comprising a non-metallic security element according to any one of claims 1-13.
